(19) United States
(12) Patent Application Publication
(10) Pub. No.: US 2005/0144150 A1
(43) Pub. Date: Jun. 30, 2005

(54) Remote process capture, identification, cataloging and modeling

(76) Inventors: Shankar Ramamurthy, Herndon, VA (US); Ravi Ramamurthy, Bangalore (IN); Chandrashekar Ramamurthy, Bangalore (IN)

Correspondence Address: SCHIFF HARDIN, LLP;PATENT DEPARTMENT, 6600 SEARS TOWER, CHICAGO, IL, 60606-6473, US

(21) Appl. No.: 10/748,970

(22) Filed: Dec. 30, 2003

(51) Int. Cl. G06F 7/00; G06F 17/00; G06F 15/18; G06N 5/00; G06G 7/00; G06F 17/10; G06F 7/60; G06N 5/02

(52) U.S. Cl. 706/45; 706/46

(57) ABSTRACT

A system and method for remote capture, identification, cataloging, and modeling of processes remotely captures the processes performed by a user on a machine, for example, a computer. Capture may include capturing input to the computer and manual tasks via video and/or audio capture. The tasks are identified, cataloged and stored. Modeling is possible by streaming the captured data back to a computer. The captured data may be edited and the edited versions compared or benchmarked by performing simulations of each.

### BACKGROUND OF THE INVENTION

1. Field of the Invention

The present invention relates generally to a method and apparatus for capturing user input and processes, identifying and cataloging those processes and modeling the processes, for example, for optimization, and in specific embodiments to capturing business process performed by a computer user or other person at a computer and modeling the captured processes. In one embodiment, the capture of the user input and processes is automatic.

2. Description of the Related Art

In business, people do their work through processes, performing the work processes step-by-step. A person may take twenty steps to complete a daily task at work. It would be an improvement if unnecessary steps were eliminated. Examples of some tasks a person in a business might perform are preparation and mailing of invoices, or collecting information from a file, making related telephone calls and sending a letter on the findings.

Users of business software develop procedures and habits for performing the business processes they are to perform as part of their job. These procedures and habits are often not particularly efficient and can include unnecessary steps, repetitive or inefficient practices, business tools and software that are not tailored to the tasks at hand, etc. They also require specific knowledge and training to make decisions and perform these processes effectively, that is rarely provided to a user. Previously, elimination of the laborious practices required interviews of the persons in the business, task analysis and observations, video-recordings of the task, note taking by an observer and review of the notes, quality assurance (QA) checking, reviews of the procedures by a committee, etc. In other words, a substantial manpower commitment, of a scarce and expensive skill variety, is required to examine the practices in an effort to reduce the waste and guarantee effectiveness of process performance. Increasing efficiency and effectiveness without requiring such procedures would make it affordable for organizations to attempt this more frequently.

Organizations have invested lot of money on current Information Technology (IT) infrastructure and many are faced with the problem of how to extract unrealized values from these large enterprise applications (i.e. software). Business process have become complex and are dependent on large, complex and many times enterprise wide applications. It is difficult and expensive to analyze and assess broken or inefficient business processes. Changes in the software applications lead to long cycles of development and implementation in order to make the changes necessary to affect the process changes.

An example of an enterprise systems which monitors, benchmarks and finds usage of hardware resources is Tivoli, but no tool is available to find out the usage of the costliest business resource—the human resource.

### SUMMARY OF THE INVENTION

The present invention provides a remote capture capability for capturing input and information on business processes, such as processes performed by a user, using human interaction logging on a user's computer or workstation, as well as audio and video monitoring of the user while performing the business processes. In particular, the present invention captures all human interaction of the user with the application programs (the operational aspect of many business processes) that are running on a computer workstation, for example, or other computer or machine or business tool, including the telephone. Process steps performed by the user and process information, for example relating the steps to the task being performed, is captured remotely across multiple users and multiple applications.

According to another aspect of the invention, the processes that have been captured are cataloged and analyzed, after which the processes are modeled. The process analyzer identifies and analyses processes for improvement in efficiency, elimination of unnecessary steps and changing the procedures and tools to implement the improved process steps. The analyzer models and links the processes to a high level definition of the processes and implementation models.

By capturing, analyzing and modeling processes, including technical processes, fundamental problems that many enterprises face today are addressed. Whereas other technologies define processes at a high level, the present system allows the process to be defined at a micro level (a single interaction with an application). Because of this, it is possible to analyze and model processes automatically. The present system thus provides capabilities not previously available by providing a core capture engine which can, in an embodiment, capture all the interactions of one user or many.

### BRIEF DESCRIPTION OF THE DRAWINGS

FIG. 1 is a schematic diagram showing the relationship of the present method in the operation of a company;

FIG. 2 is a block diagram of a process development environment of the present method and system;

FIG. 3 is a block diagram showing the process capture according an embodiment of the present invention;

FIG. 4 is a functional block diagram of a process capture, identification, cataloging and modeling system according to the principles of the present invention;

FIG. 5 is a block diagram of the remote process capture technology;

FIG. 5A is a block diagram that illustrates synchronization of manual and computer tasks;

FIG. 6 is a schematic illustration of different levels of process capture that may be utilized;

FIG. 7 is a schematic illustration showing the life cycle of the data that has been captured during the capture portion;

FIG. 8 is a branching block diagram showing an instance of a process to be captured and modeled;

FIG. 9 is a block diagram showing relationships between levels of abstraction in the process model;

FIG. 10 is a is a block diagram showing the process analysis and modeling of the present invention;

FIG. 11 is a block diagram of utilization of modeled process with a user;

FIG. 12 is a table of the information captured while a user is interacting with an application, showing the workflow header information;

FIG. 13 is a table of the information captured while a user is interacting with an application, showing the a first portion of the basic step information;

FIG. 14 is a table of the information captured while a user is interacting with an application, showing the a second portion of the basic step information;

FIGS. 15, 16 and 17 are flow diagrams of a sample process according to the present invention; and

FIG. 18 is block diagram showing the present system in use.

### DETAILED DESCRIPTION OF THE PREFERRED EMBODIMENTS

In an aspect of the invention, human interactions with software applications running on a computer or workstation are captured and extracted remotely in the form of XML (extensible Markup Language) scripts as the human, or user, is performing tasks. The XML scripts of the process are representations of the human interactions with the software application at a level of specificity and detail such that the XML script can be streamed back into the application software and thereby masquerade as a human operator performing the process. The capture and modeling can be accomplished for just one software application or for several applications being used by one user or by several users. This represents a first of seven improvements or features provided in the various preferred embodiments.

According to a second aspect, an embodiment of the invention creates virtual footprints in the software application to serve as a real-time context determination, in the form of context points, that identify when the user is interacting with the software application. The virtual footprint identifies where in the software the user has been to that the steps being taken by the user may be identified and the items being performed placed into context. The virtual footprints and context points are used in the present method for the process capture and modeling, and may also be used by third party systems or in other software, processes and systems to integrate disparate systems and content and to fuse knowledge into processes based upon a user's specific goal. The context capture may also use “listeners”, which monitor and record communications between components of the software and/or the operating system.

A third aspect provides that audio and/or video recordings are made to capture activities, such as the activity of the user and others, that are not directly the result of interacting with a software application on the computer or workstation. For example, the telephone discussions by the user, meetings in which the user participates and physical activities by the user in performing the tasks are captured, preferably as XML components or elements to contextualize the relevance and relationship of a user's interaction with the software application(s) with the task at hand. The recording includes context markers and time stamps to aid in matching and synchronizing different recorded portions with other captured data. This capture of the manual elements of the user's process can use other recording and/or capturing measures in addition to or in place of the audio and/or video recording.

Once captured, the XML processes are stored in a repository. In a preferred embodiment, the repository is an enterprise specific database. In this fourth aspect, the processes can be reviewed, edited and enriched, for example, using a presentation system. One example of the presentation system is presentation software, such as Microsoft PowerPoint (a trademark of Microsoft Corporation). The presentation system displays the process information and permits editing of the process information. The display of the information is in an self-organized hierarchy with self created text in any desired language. The presentation system also displays related annotations, images and graphics of the user and the application interactions combined with the captured audio and video data of the activities surrounding and relating to the interaction, or process. In this way, all of the captured data relating to the process, no matter how captured or in what form, is presented together

In an improvement according to the present method and system, the processes may be stored in BPML (Business Process Modeling Language) compliant XML standards and can be exported to other formats as well. The XML file formats may be translated to the BPML format by standard translation systems and/or software.

In the fifth aspect, the captured processes are used to model the processes as “as is” processes or as “to be” processes. In other words, the “as is” processes are those that are being used by the users prior to utilization of the present method and system, i.e. pre-existing processes, whereas the “to be” processes are those which have been improved and/or edited using or assisted by the present method and system, i.e. proposed processes. Put another way, “as is” processes are processes that organizations are currently following and “to be” processes are processes that they want to follow. In order to move from “as is” to “to be” processes, various elements may be involved. This may simply require customizing existing processes and applications, introducing new processes or new applications to serve the existing processes better, or modifying processes and then changing the underlying applications.

The processes can be linked to other external process models at various levels. The modeling allows multiple levels of the processes to be modeled.

For the sixth aspect, specific processes are extracted automatically as a user performs various operations. Processes are defined by a rich mechanism for defining the processes. The process definition is a rule based XML process standard. Process definition is applied to remotely captured files so as to yield details of the processes that are being performed by the user. These are further analyzed and used as a basis for modeling of the “as is” and “to be” processes in an organization or business. The use of the XML formatting permits an examination of a user's detailed interactions for analysis of the processes.

For a seventh aspect of the present invention, a comparison, or benchmarking, is performed either between the best practices and either the “as is” processes or the “to be” processes or between the current practices of the user and either or both the “as is” and “to be” processes. Other comparisons or benchmarking may be performed as well. This has amongst other aspects, an immediate relevance to businesses attempting to demonstrate their compliance with Sarbannes Oxley or HIPAA (Health Insurance Portability and Accountability act of 1996) or other regulatory requirements.

In one embodiment, benchmarking is done between the following: “to be” verses “as is” processes, performance at any point of time with “as is” processes, or performance at any point with “to be” processes. So “as is” and “to be” processes can be used for benchmarking as well as for other purposes.

The XML process information is particularly useful in the present method and system by virtue of the self-descriptive nature of the processes which lends itself to extensive manipulation by modeling and programming, or to examination and analysis through database querying, mining or pattern searching. Other languages or process definitions for the process capture and manipulation are of course possible and are envisioned for use in the present method and system.

A remote administrator determines the capture settings for the process to be captured. In particular, the administrator determines what to capture, what not to capture, and when to capture the processes. The remote administrator may be linked to the capture site by a network or otherwise. The administrator may set the capture settings in real time as or just prior to the process capture, or preferably well in advance to the capture. It is also within the scope of the present invention that the administrator may be local to the capture site, or to at least one of a plurality of capture sites.

A cataloging of the processes is performed automatically. The cataloging is performed by pattern matching between the processes being performed by the user and the process definitions. A match in the patterns results in an identification of the process. After cataloging, the process is available for analysis and modeling. For example, the cataloged processes are preferably made available on a server. The information on the processes is preferably automatically uploaded to the server.

In a preferred embodiment, the present method helps to determine the processes that are currently in use, analyzes the performance of the processes, develops the best practice processes, develops “to be” processes, and benchmarks the performance of the “to be” processes against the best practices. The preferred embodiment may be used in Windows based operating systems, in Internet Explorer (a trademark of Microsoft Corporation) based applications, in JAVA based applications, and in SAP (Server Application Programming) applications. In addition, specific applications such as CATIA (Computer-Aided Three-Dimensional Interactive Application), Solidworks and Pro Engineer may be utilized in the present embodiment through the use of special adapters. Of course, the principles of the present method are not limited to the operating system or application and can be applied to nearly any software application and/or business process, by provision of an SDK (Software Development Kit) of APIs (Application Programming Interfaces) that allows easy programmatic extension to any application environment.

The present invention is used by users of various categories, including users whose actions are to be captured as input for further analysis and modeling. Examples of users include employees of a business or organization, members of internal departments of a business or organization, users in partners of a business or organization, customers or users employed by customers of a business or organization, etc. In this way, the business or organization can track the processes and the changes thereto not only within the enterprise but also its effects outside the enterprise. The users may be users of the above-noted applications and operating systems, although it is of course possible to apply the present invention to other applications and operating systems. Analysts also use the present invention, in particular the process modeler and analyzer, to develop the “as is” and “to be” processes and the best practice models based on the captured processes of the users. An administrator also is involved in the operation of the present system, and defines the capture parameters, including whom to capture, when to capture, what to capture and what not to capture.

Preferred embodiments of the invention are described and shown below with reference to the drawings.

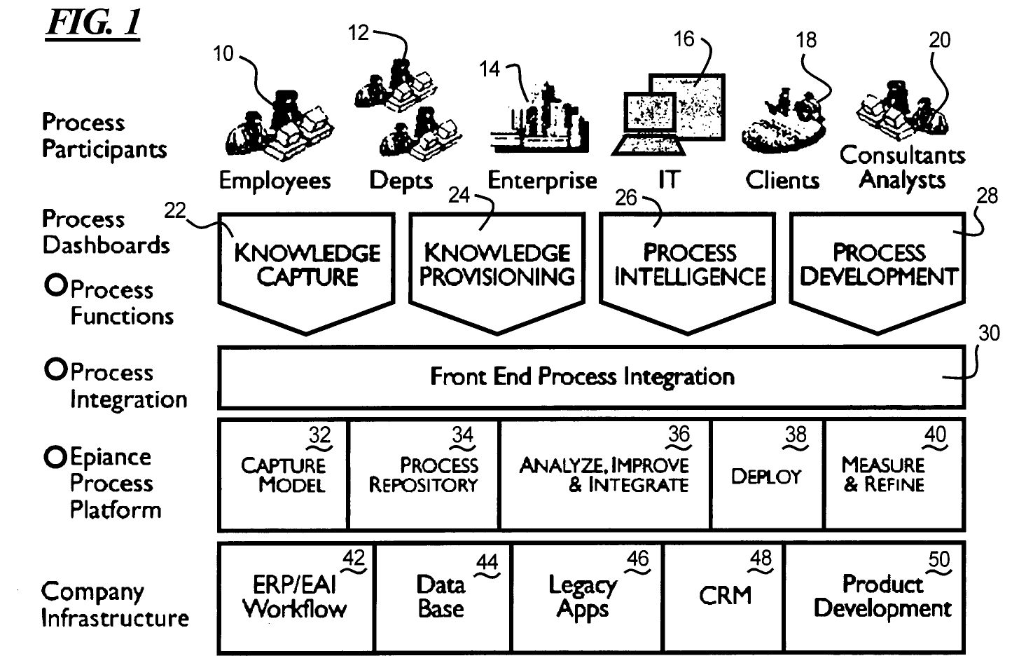

FIG. 1 illustrates the participants which can utilize the present method and system particularly as it relates to a business, including employees 10, departments 12, the entire enterprise 14, the information technology (IT) department 16, clients or customers 18 of the company, and consultants and analysts 20. While the present invention is being described in conjunction with a company or business, it is also foreseeable that it may be used with government agencies, non-profit institutions, and other groups, organizations and entities and the scope of the invention encompasses these. In FIG. 1, the process functions performed according to various embodiments and features of the invention include knowledge capture 22, knowledge provisioning 24, process intelligence 26 and process development 28. These lead to a front end process integration 30, which in turn is based upon a platform of capture and model 32, providing a process repository 34, analyze, improve and integrate the process 36, deploy the process 38, and measure and refine the process 40. This works with the company infrastructure including the Enterprise Resource Planning (ERP) and Enterprise Application Integration (EAI) workflow 42. The company database(s) 44 is(are) used as well as the legacy applications 46 in use at the company. Other departments/components of the company involved in this process can include the Customer Relations Management (CRM) and product development 50 departments.

A comprehensive business process performance platform is thereby provided which incorporates front-end process integration solutions, efficiently linking business processes that people use to disparate software applications. FIG. 1 illustrates how the present system may be incorporated into the existing Enterprise Services Architecture (ESA). Utilization of these improvements provides increases in personnel productivity through reduced process complexity while establishing, measuring and testing of process benchmarks.

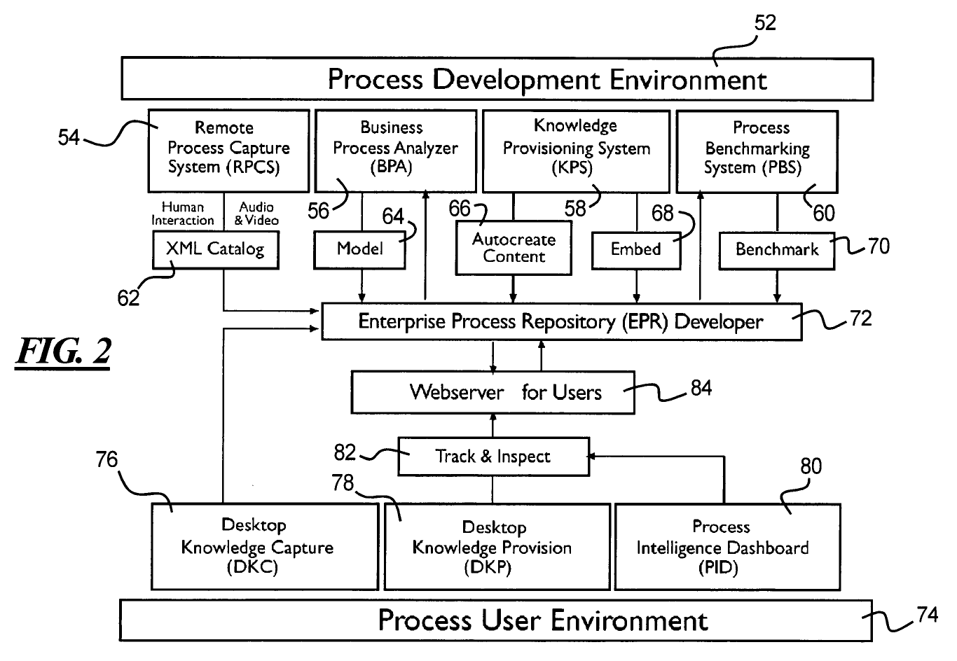

The process development environment is shown in FIG. 2. This process development environment enables a business to improve the business processes. The process development paradigm permits technical users and specialists to use process capabilities and functions to design business process solutions. The process development environment 52 transforms disparate applications into context and process aware applications. The application context awareness is leveraged to establish a business process goal awareness and link to specific context points in the applications.

Elements of the process development environment include a Remote Process Capture System (RPCS) 54, a Business Process Analyzer (BPA) 56, a knowledge provisioning system 58 and a process benchmarking system (PBS) 60. The remote process capture system 54 provides for automated capture of user processes including human capturing of human interactions as XML elements that are stored in an XML catalog 62. Audio and video recording are also provided. The remote process capture collects the process and process information across all users and applications.

The business process analyzer 56 identifies and analyzes the processes for improvement. The analyzer generates models 64 and links the process to high level definitions and implementation models.

The knowledge provisioning system 58 leverages process models to generate automated and simplified interfaces for the applications, content 66, knowledge fusion, business process documentation and e-learning content. A significant portion of the human effort required to create and maintain content is eliminated. The knowledge is embedded into the enterprise's applications and systems at 68.

The process benchmarking system simplifies the process performance requirements by performing the benchmark testing 70, including development and application of performance requirements, process intelligence and measurement of the process being performed.

Each of the foregoing elements 62, 64, 66, 68 and 70 directs data to an enterprise process repository (EPR) developer 72.

At the bottom of FIG. 2, the process user environment 74 provides business users and analysts and strategists with a single environment for obtaining real-time business knowledge, best practices, process information, front-end automation and intelligence of real world business processes that are used. The process user environment 74 automatically transforms context aware applications into context interactive applications by tracking user context to assemble just in time and real time information, interfaces and resources as needed.

The elements of the process user environment include the desktop knowledge capture (DKC) 76 which enables tracking and inspection of a business user's processes, a desktop knowledge provision (DKP) 78 that provides a simplified process based user interface with real time knowledge fused into the process, and a process intelligence dashboard (PID) 80 that provides process intelligence for key personnel of the enterprise. The desktop knowledge capture forwards data to the enterprise process repository developer 72, whereas the desktop knowledge provision 78 and process intelligence dashboard 80 forward their data through a track and inspect step 82 and a webserver for users 82 that interfaces with the enterprise process repository developer 72.

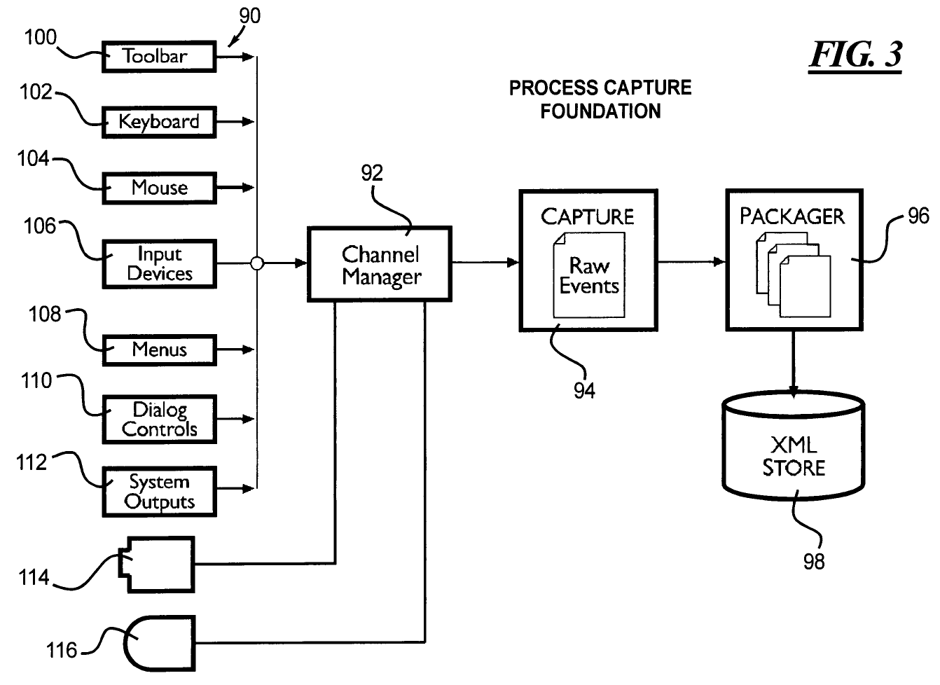

FIG. 3 shows the capture technology of the present invention, including input devices 90, a channel manager 92 (also referred to as a data manager), a capture unit 94, a packager 96 and a storage 98, for in this case XML elements. The input devices 90 include a toolbar 100, a keyboard 102, a mouse 104 (or other cursor pointing device), other input devices 106, menus 108, dialog controls 110 and system outputs 112. The menus 108 and dialog controls 110 are elements of the software applications being used by the user during the capture of the business process. These can be considered the virtual footprints of the process through the application.

So called “listeners” are provided to realize the capture from the input devices. The listeners are software components of the capture technology that are installed on the computer system of the user and “listen” for communications between the operating system and the application. The messages which are captured during the capture operation are then passed on to other components as during the ordinary operation of the computer.

In particular, a listener is the component of the capture technology which captures all the events in the raw form. The listener sits in between the operating system and the user and listens to all the traffic. Listeners at the server side can listen to database events and other Server events. The listener captures information and stores them in a structure. A list of information captured is provided later in this document.

Listeners are available as plug-ins also. The present invention encompasses having separate specific listeners for various applications. This is because the method of capturing information varies from one application to another. Also the format of information provided is different in different applications. In one example, the listeners include plug-ins for SAP, Browser based applications, JAVA based applications and Windows based applications.

Listeners have a notification mechanism. Various external clients can register themselves with the listeners and can request to be notified. Notification can be request for specific user actions, specific user actions on a UI control, or all user actions

Each of these input devices 90 is monitored by the listeners, which forward the data to the channel manager 92. The capture unit 94 receives the output from the channel manager 92 in the form of raw events. The raw events are packaged in the packager unit 96 and forwarded to the storage device 98. The storage device 98 stores XML (eXtensible Markup Language) data.

In this context, a user working at a task on a workstation or other computer with activate one or more of the input devices 90 in the course of performing the task. The input devices capture all control information on the screen, the control data, screen images, and control images. The captured process information is provided through the channel manager 92 for recording (capture) 94, packaging 96 and storage 98. The channel manager 92 decides what channels are used for what events as the message data is streamed through the various channels. The data may include such things as Windows Standard data, 16 bit data, Windows MSAA data, JAVA data, IE data, and SAP data.

The capture technology uses XML scripts within and across all business applications to capture the user's interactions. For example, the menus 108 and dialog controls 110 and toolbars 100 are common elements across many or even most business software applications. This means that the capture of these inputs is provided in all of the applications used by the user without requiring a separate capture interface for each application. Further, this does not require access to the source code of the applications. The common elements of the capture interface are shared as between applications. The capture may be triggered remotely on designated target user's desktop computers and applications by an administrator.

Manual processes are captured as well. These manual processes surround the machine-related human interaction processes and are mainly unstructured content such as telephone discussions and physical activity. The activity is captured using audio recording, video recording and text capture. In one example, a video recorder 114 is provided for recording the video component of the capture and a microphone 116 or other audio pick up is provided for the recording of the audio data, as shown in FIG. 3. Although a standard video camera using magnetic tape or other magnetic media or solid state media may be used, the present invention utilizes in a preferred embodiment a video camera connected to a computer for recording onto the computer hard drive. Such devices are known commonly as web cams, although other varieties of video recording cameras and detectors are of course readily used in this application, including stand alone and built in cameras. Still cameras may also be used in the capture of the visual data, primarily for reasons of increased clarity and image integrity, although the timing of the still images must correspond to the actions of the user to be captured. Several video recording devices may be provided as needed. For purposes of the present invention, video data includes both still images and moving images.

The audio portion of the capture may be by a standard microphone 116 located wherever convenient to the user's activity. A built in microphone on the computer may be used, or a separate one. Due to the limited range and distance of detection for microphones, several microphones may be included. Since important information regarding the process to be captured may be discussed by the user via telephone, the audio detector 116 may be the telephone used by the user, or an additional recording device attached to the telephone, which records one side and preferably both sides of the user's conversation.

The stored audio and video data from the video recorder 114 and audio detector 116 in one embodiment are stored as compressed files, such as MP3 files, WAV files or other Windows Media Player compatible file formats. In a preferred embodiment, the Windows Media Player is used to record and store the video and audio files. Of course, a user may define his or her own format for recording the media data.

A communication link must be provided during the remote capture to transmit the data to the storage and/or analysis components. The communication link may be any type of link but in its preferred form is a network connection, such as an office network, to the computer being monitored. Examples include LAN, WAN, or other network constructions. It is preferred that an http protocol be provided for communication between the server component and the client component during the capture, and in some cases a network connection with an IP protocol is also needed.

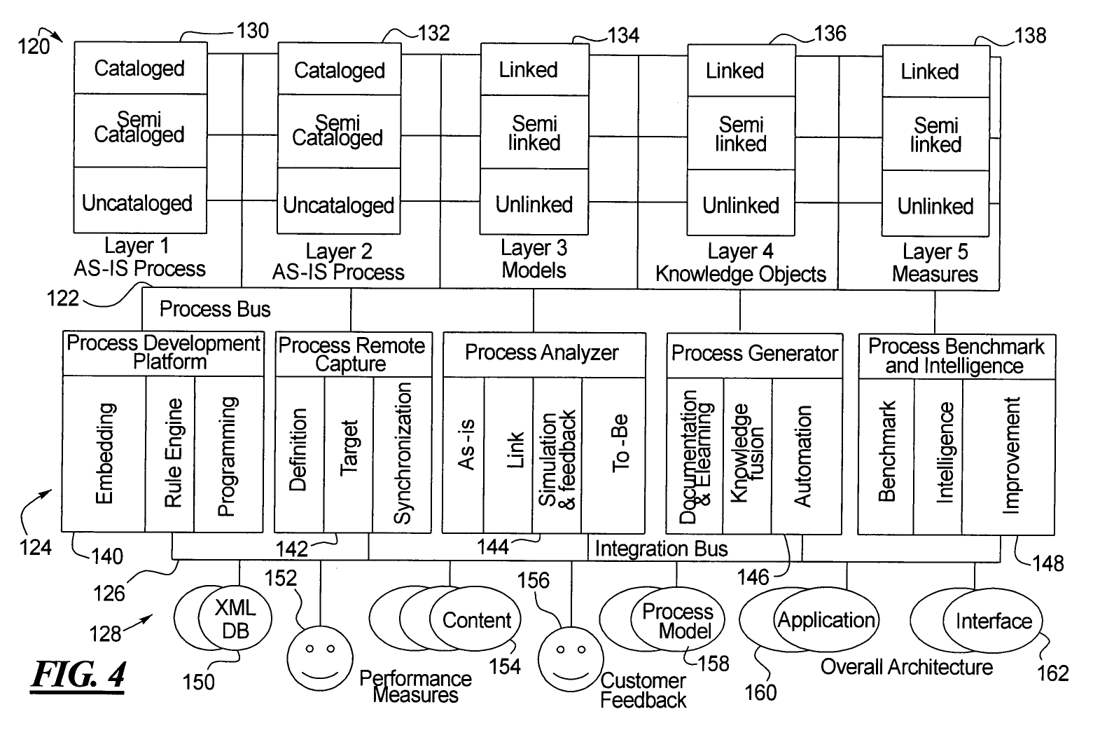

Referring to FIG. 4, the remote process capture technology is used to capture “as is” processes and “to be” processes. So called “as is” processes are those that are in place at the beginning of the analysis, or otherwise at a predefined time or as a redefined standard against which progress is measured. The “to be” process are those which have been modified or improved through the application of the present technology as well as other analysis, adjustments, tweaking and changes. The “to be” processes may be the result of changes outside the present method and system, but which are the result of problems identified using the present technology, such as identification of bottlenecks and duplication. The “to be” processes are useful to measure whether a return on investment (ROI) may be realized by make the change or whether the goals sought by the organization are realized. The “to be” processes are used in the benchmarking process as will be discussed in greater detail.

The “as is” and “to be” processes are catalogued and stored in a repository 120 in FIG. 4, which may be or may include the storage 98 of FIG. 3 or which can be separate therefrom. Process generators can be used to generate and autolink knowledge objects and content with the “as is” and “to be” processes. Based on the “as is” process, process analyzer technology analyzes the process and gives the necessary information for the analyst to design the “to be” processes. Later, when the actual “to be” processes are implemented, the remote process capture technology can be used to record the complete “to be” processes. Process benchmarking technology can be used to measure and compare the implementation of “to be” processes with the best practices. Process benchmarking technology can also suggest a revised best practice. Gaps in existing processes and broken processes can be identified using the process benchmarking technology. Process intelligence technology is use to notify specific events to users.

As shown in FIG. 4, the main technology components of the system are the repository 120, a process bus 122, a developer and process user layer 124, an integration bus 126 and external interfaces 128. In the repository 120 is stored the process models (both “as is” and “to be” process models), central content derived from the process models, and central definitions necessary to drive other modules. The illustrated repository has five layers corresponding to “as is” process models 130 , “as is” process content 132, models 134 (which may be the “to be” process models), knowledge objects 136 and measures 138.

The process models, such as the “as is” process models 130 and the corresponding content 132, themselves can be catalogued, semi-catalogued or un-catalogued, as indicated by the divisions within the repository layers 130 and 132. As users perform various processes, the remote process capture identifies the processes the users are performing and catalogs and stores them accordingly. The known processes are stored as cataloged processes in that part of the repository. In some cases, the processes that users are performing cannot be identified with precision. In some cases, some fuzzy parameters can be identified and weightings may be given (i.e. 50% possibility that process A is being carried out and 50% possibility that process B is being carried out). Of course, other percentages are used when applicable. The fuzzy parameters are applied based upon the likelihood that a process definition can be applied. If the process matches more than one process definition, the fuzzy parameters (fuzzy logic) are applied, with the values reflecting the likelihood of a match to the corresponding process. In such cases, the processes are stored along with these weightings in the semi-cataloged portion of the repository. The conflicts or questions over what process is being performed are resolved at a later stage. These processes are called as semi-catalogued processes. Finally, some processes cannot be categorized at all. Such processes are dumped as a blob in the un-cataloged portion for further analysis.

In some cases, the intention may be to capture but without categorization. In such cases also, the captured information is stored without any kind of cataloguing and so the storage would take place in the un-catalogued portion of the repository 120.

While cataloguing the processes, meta data and information about the processes are also stored along with the captured processes. These are used for discovery and search purposes. The repository also contains definitions (including process definitions and target definitions) and other information common to the enterprise. The remote process capture and other modules use this information. The repository 120 in the models 134, knowledge objects 136 and measures 138 has linked, semi-linked and unlinked portions. Each of the repository 120 portions is connected to the process bus 122.

The developer modules 124 are also connected to the process bus 122. The developer modules 124 automatically generates content and knowledge objects based on the processes that are catalogued and captured and then stores them in the repository portions 132 and 136. The knowledge objects 136 and content 132 are auto linked with the processes. These are also maintained in the enterprise repository 120.

The process bus 122 is a set of APIs (Application Program Interface) and an interface to the repository 120 as well as to other systems. Using the process bus 122 and the process development system 122, external modules can search for processes or read process information from the repository 120. They can also access the APIs of the individual systems of the present invention.

The developer and process user tools 124 provides automatic generation of content and knowledge objects using these modules. For example, a process developer platform component 140 has embedding, a rules engine, and programming portions, the remote process capture component 142 has definition, target and synchronization portions, the process analyze component 144 has “as is”, link, simulation and feedback and “to be” components, the process generator 146 has documentation and e-learning, knowledge fusion, and automation portions, and the process benchmarking and intelligence component 148 has benchmarking, intelligence, and improvement portions.

The integration bus 126 provides the communication link between the developer layer 124 and the interface layer 128. The integration bus 128 sets a specific XML protocol which uses the modules to converse with the outside world.

The external interface technology 128 includes external interfaces to configuration management systems, databases and external process modeling systems. The external components shown are the XML database 150, performance measures 152, content 154, customer (user) feedback 156, process models 158, applications 160 and interfaces 162.

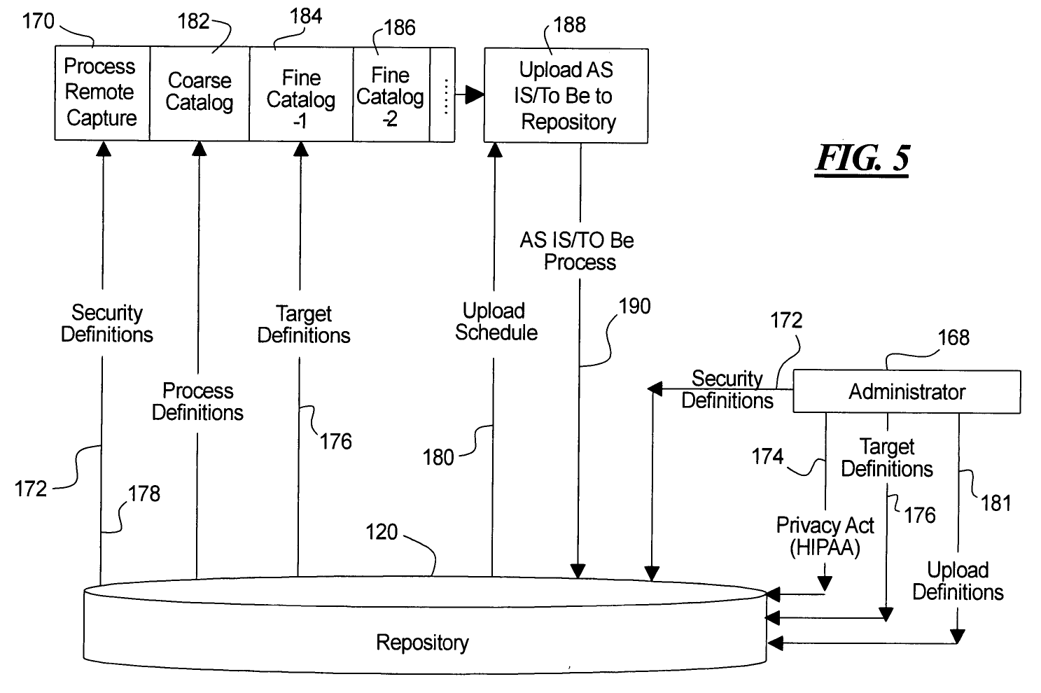

FIG. 5 provides further information on the remote process capture technology. The remote process capture technology, as mentioned above, is used to capture and catalog user actions and store them in the repository 120. The diagram explains the overall functioning of remote process capture technology, wherein

The process remote capture system (denoted here as element 170 but shown in greater detail in FIG. 3) is used to capture the “as is” and “to be” processes. The capture is done on the basis of various definitions set by the administrator 168. The important definitions are:

1. Security definitions 172: these include the parameters that should not be captured by the remote process capture. Information such as passwords or other sensitive information can be removed from the process capture system.

2. Privacy act information 174: Privacy acts such as HIPAA (Health Insurance Portability and Accountability Act of 1996) and others define some sensitive information, which should not be made available. Social Security numbers or some specific patient information (for health care applications) can be blacked out of the capture files. Accordingly the process remote capture system does not capture any of this information.

3. Target definitions 176: The target definitions are used to define the source and target of the process remote capture. They answer the questions:

a. Who should be captured?: Defines users whose processes are to be captured.

b. When to capture?: These could be calendar schedules (e.g. capture users on Mondays and Tuesdays from 10:00 am to 6:00 pm) or what specific applications to be captured. Capture can also be enabled on specific events that happen.

c. For whom?: the capture information can be sent to a destination. Typically the destination is the repository 120,

4. Process definitions 178: Process definitions are process strings, which are used to uniquely identify a process. Process definitions are defined using the process analyzer. The process remote capture catalogs processes using the process definition.

The process definitions may be defined in two ways. An analyst may open a captured file and then mark out the key steps required for the process definition. Or, the analyst may go directly to the application and mark out the key steps that are required for an application. Once a process definitions are defined, the process analyzer can run through the entire captured process in one pass.

5. Upload schedule 180: The upload schedule defines when the process file should be uploaded to the repository. Captures processes can be uploaded when the system is idle or can be uploaded at specified intervals.

The administrator 168 also addresses the upload definitions 181.

Multiple levels of cataloging are provided to catalog the process better. Coarse cataloguing 182 is typically a real time activity and is performed as and when the user is performing an action. To catalog in a better fashion, fine level catalogs 184 and 186 are used. Some of the fine cataloging is performed in a batch mode.

The final catalogued processes are then uploaded at 188 into the repository 120 as shown at 190.

While determining the processes that are in use or the “as is” processes, remote process capture may have to be deployed in many user machines. As a result the size of the captured data may be enormous.

FIG. 5A illustrates the synchronization of the capture of the computer process steps and the manual process steps. In the illustrated example, a human/system interaction aspect is shown in column 192, a manual process is shown in column 194 and a capture of the system and manual process steps is shown in column 196. In the manual process 194a, the user receives a call from a customer, which is recorded via audio, video or both. The user opens a CRM (customer relations management) application on the computer at 192a. These are captured at 196a on the system. At 194b, the user asks the customer for the customer's identification, which is entered into the computer at 192b, causing the customer record to open. These actions are captured at 196b. The identity of the customer is confirmed by verifying customer details at 194c, that is confirmed on the computer at 192c and captured at 196c. The user asks the customer the question, “May I help you?”, at 194d, to which the customer replies in this example by voicing a complaint (1), requesting new a service or product (2), or changing the customer information (3), as shown at 194e. These three categories of responses cause the user to select a corresponding screen or link on the computer at 192d, opening follow-up steps at 192e for each of the categories of response. This is captured as one of three paths 196d with a corresponding number of steps, at 196e. At the completion, the user thanks the customer, at 194f, and closes the customer file, at 192f, that is captured at 196f. The computer steps 192 are captured at the same time that the audio and/or video files of the manual process 194 are captured, and the audio and/or video files are tagged with identifications of the corresponding computer steps 192.

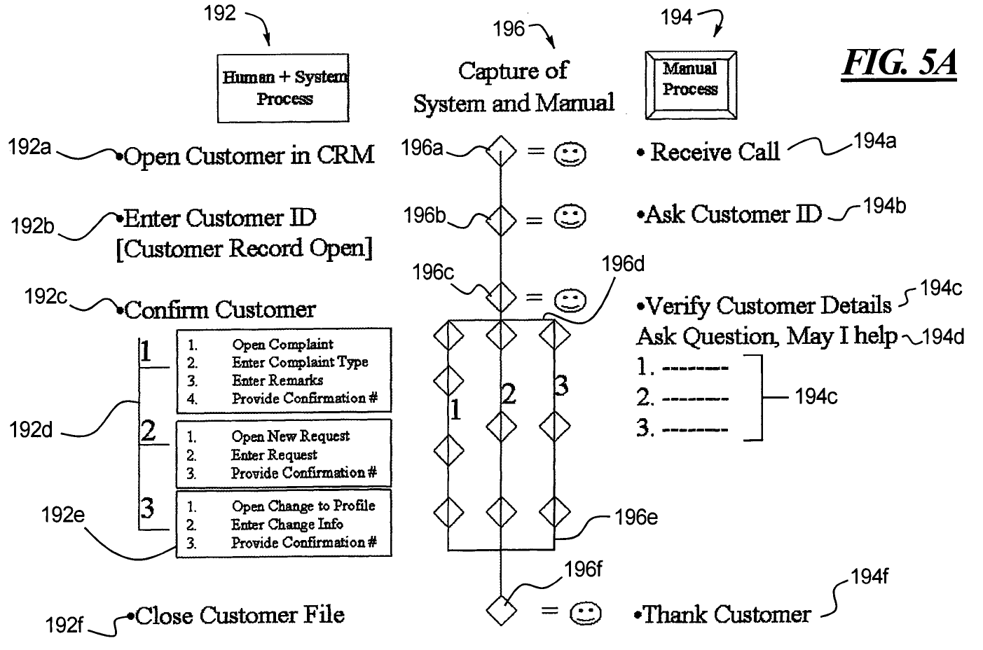

FIG. 6 illustrates the various levels of capture. At the left hand side is shown the basic capture 200 (only events and no images/sound/video) which is used to determine the “as is” processes that are being used. The second level of capture 202 involves events and images. Images need to be captured only when customer feedback is being sought. At the third level of capture 204 events, images and audio is captured. This level of information may be required to formulate the best practice or to determine the gap between a best practice and the process that is actually followed. The fourth level capture 206 which includes video is to be used sparingly. Level four 206 and level three 204 capture are required when it is necessary to determine the manual activities that are followed as a part of the process.

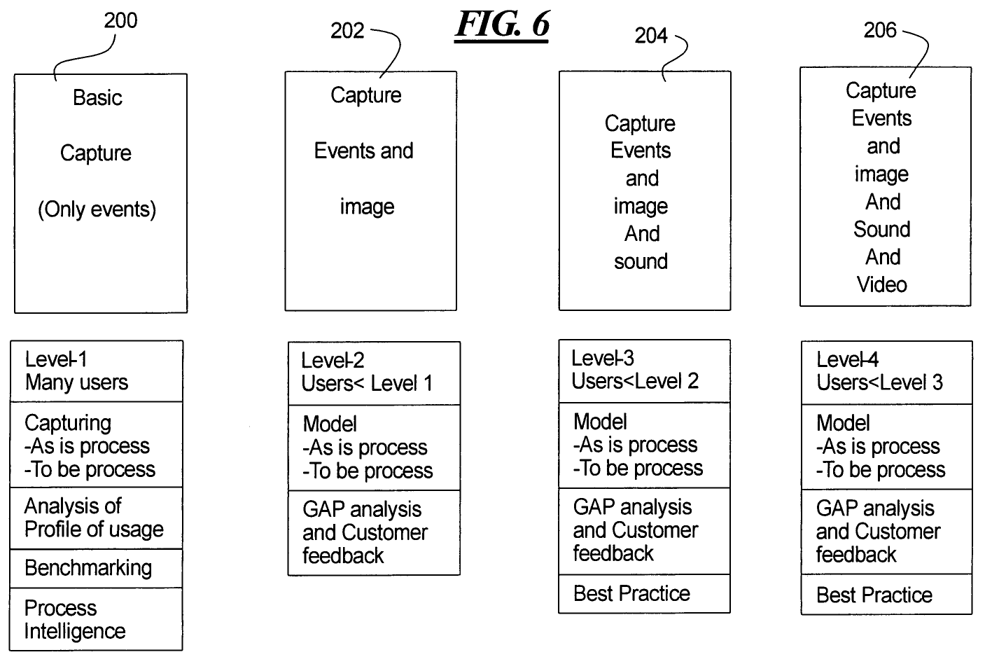

The lifecycle of the captured data is illustrated in FIG. 7. The initial “as is” processes 210 that are captured are condensed into a summary table 212 and exported to any database. The summary information includes the details of processes used along with time taken and other metrics. The processes are also catalogued and refined further as shown at 214. At this stage 216, a few instances of the processes have been captured. The remaining information can be purged or archived for future use as shown at 218.

The captured data analysis determines the context of the captured data on the basis of the current dialog or control that the user is interacting with and by the history of the dialog or controls that the user has interacted with.

Once a list of cataloged processes 216 has been obtained, it may be necessary to study manual or other aspects of the process. Images, sound and video are captured at 220 from a select few users according to some embodiments of the invention and the captured process are further condensed into a set of existing practices for the process, as shown at the refined catalog 222. Other information may be purged or archived at 218.

The audio and video files are played back in segments that are tagged for identification with the corresponding steps recorded as input to the computer work station. The segments show the analysts exactly what has happened between each step.

The study of the manual aspects of the process involves human review of the video and audio and are used to generate the refined processes. While capturing processes, the following are capture: human interactions on the software application, audio around the user workstation, and video around the user workstations. All these richly integrated and provided to the analysts. In particular, the audio and video files are marked with tags corresponding to tasks and or steps in the process. Using the present technology, all of these are presented in an integrated fashion. For example, the analyst can find out what the user was doing after executing second step in an application but before executing the third step. In this way, specific bottlenecks in a process can be identified and removed.

A part of the process analysis is generation of reports of the findings by the process analyzer.

The present processes and their analysis and definition can include: linear or non-linear steps to be performed in an application; workflow elements involving branching and looping; manual tasks or legacy content; and hierarchy of steps.

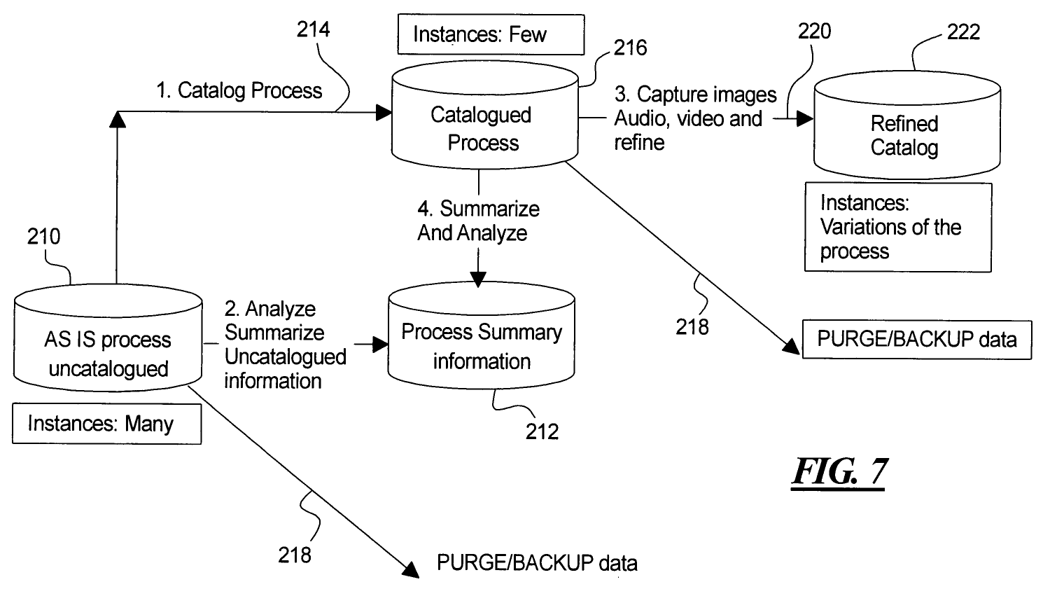

For example, the present method and system may combine the first ten steps of a process and group it under a sub-process, for example the sub-process “enter order information”. Tracking and content automatically inherits the hierarchy definition of the process. FIG. 8 shows the elements that can be used in a process definition.

The diagram of FIG. 8 illustrates that a process can also include branching elements. For example a recruitment process may have one path for temporary workers and one for permanent employees. An entire process can thus be modeled using the elements of branching/looping. These decision points are made even more powerful with the ability to invoke rules engines. These processes may be performed at one or more employee or customer nodes. For example, workflows can string processes across multiple nodes with simple linear processes, decision trees, and manual flows.

In FIG. 8, an end to end business process 230 may be broken into a linear process 232, decision trees and a rules engine 234, manual processes 236 and workflows 238. The linear process may include steps 240 and a hierarchy 242. The workflows 238 may also include linear processes 244 that are made up of steps 246 and a hierarchy 248, decision trees and a rules engine 250 and manual flows 252.

The process analysis performs a analysis of un cataloged information and performs and analysis of cataloged information. In both cases, the process analyzer gives information on what processes are being used by whom, how much time does it take to perform a process, what are the errors, performs a comparison against the best practice, determines the efficiency of performance etc. Process modeling is however used to model a “to be” or an “as is” process. The analyst may use the process analyzer report to fine tune or improve a process. Thus, process modeling and process analysis go together.

The process modeler is a set of tools are provided to model various components of a process. Modeling can be done at a very high level such as supply chain management processes or at lower level where an exact process can be described at the operation level. Process definitions are defined only for processes that use software applications. A process model is a combination of processes that use software applications and manual tasks. Any process, which uses at least one application process, can have a process definition.

The process modeler provides various elements for modeling branching and looping elements. As a result, any of the process elements can be modeled and create a WYSIWIG (What You See Is What You Get) flow using decision points and looping constructs.

Legacy content is used in the modeling process in two ways. Legacy content can be linked to a process context. This way whenever the user wants assistance, the legacy content can be shown along with the generated content of the present method. In the modeling process, legacy content can be attached to a particular process. If a particular process is a manual task and needs reference to a manual which is a legacy content, this can be done. Using the process modeler, linkages can be provided to any HTML or pdf legacy content.

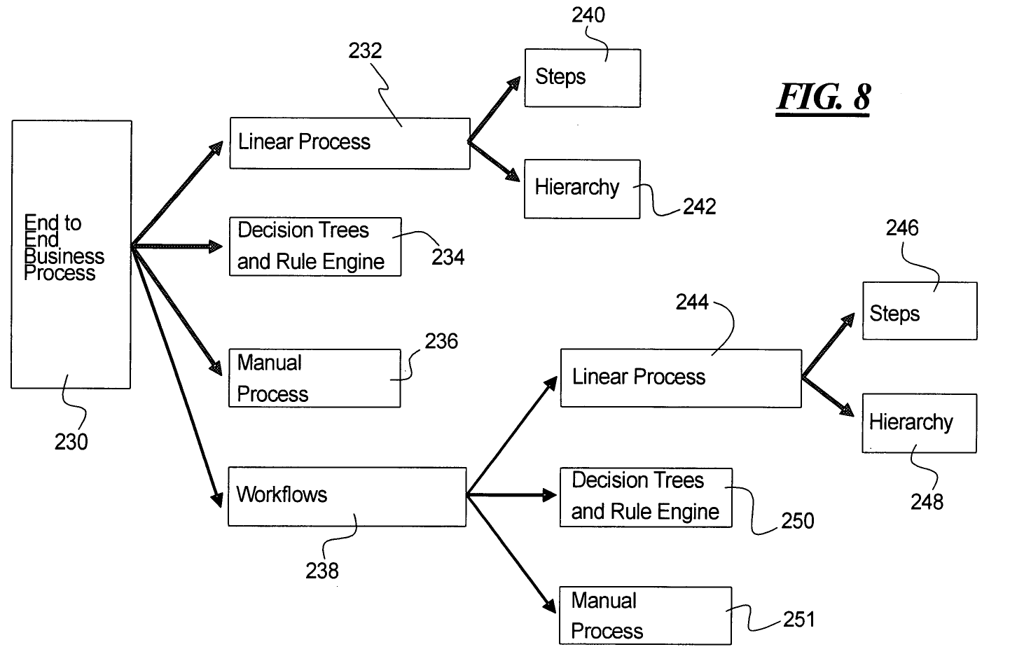

FIG. 9 illustrates an abstract process model 260 that defines variations of all processes. There may be multiple instances 262 of an abstract process model. An abstract process model may have linkages 264 to external process models or may drill down into lower level processes 266. At the lowest level is the capture file 268.

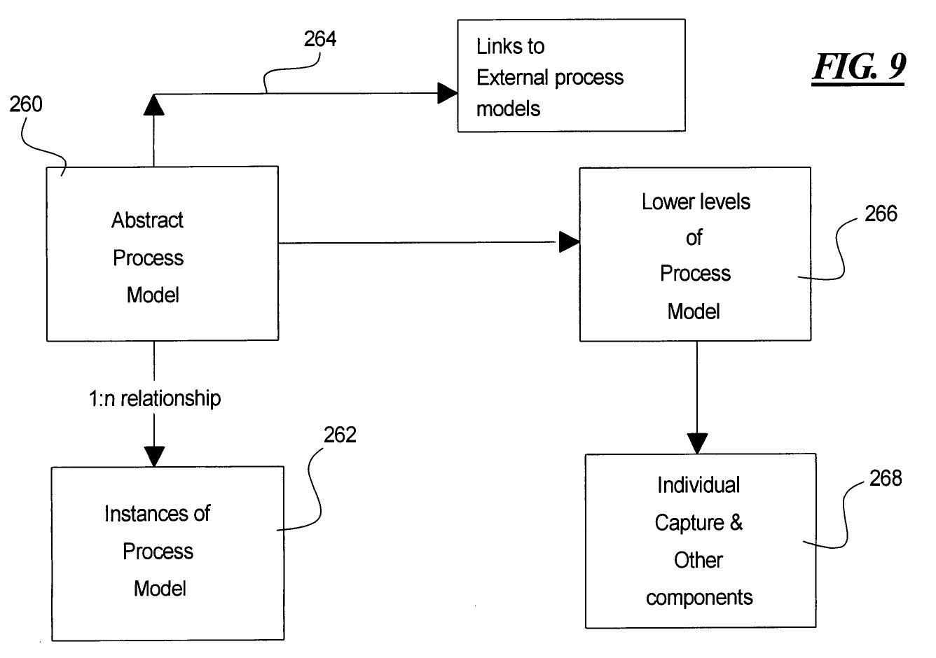

In FIG. 10 is shown the main components of the process analyzer. The main functions of the process analyzer 270 are to: analyze “as is” and “to be” processes 272 and generate reports on process usage (duration, errors etc.); help analysts to refine the “as is” processes and catalog the processes or the variations of the processes used; and catalog process capture files that have not been catalogued at 276.

As noted above, once a process definitions are defined the process analyzer can run through the entire captured process in one pass. The process analyzer is involved in cataloging of un-cataloged capture files and cataloged capture files. The semi-cataloged files generally must be manually refined before they can be analyzed.

The analyzer 270 can also accept as input information about performance measures 278 of the process. This can be used both by the analyzer 270 and the benchmarking part 280 of the present system, which may use a simulator 282.

The process modeler 284 is used to model the “as is” process and based on the user profile or usage of current processes; design the “to be” model of the process. The process modeler 284 can also be used to model the process and send it to end users and customers 286 and obtain their feedback regarding the process. This can be used to revise the process model.

The process modeler 284 can also export the process models to external models 288. A process model can also have linkages to external process models 288. The process can be simulated using the present simulator 282 and the statistics gathered can be fed back into the existing “as is”/“to be” process models.

The benchmark system 280 benchmarks: actual usage against the “as is” process model; benchmarks actual usage against the “to be” process model; performs a comparison of the “to be” process model and the “as is” process model; and benchmarks actual usage against the best practice. As a result of the comparisons, the best practice itself may have to be revised at 290.

The analyzer 270 and benchmark component forward data to XML database(s) 292 and 294. Of course, the present system interacts with the repository 120.

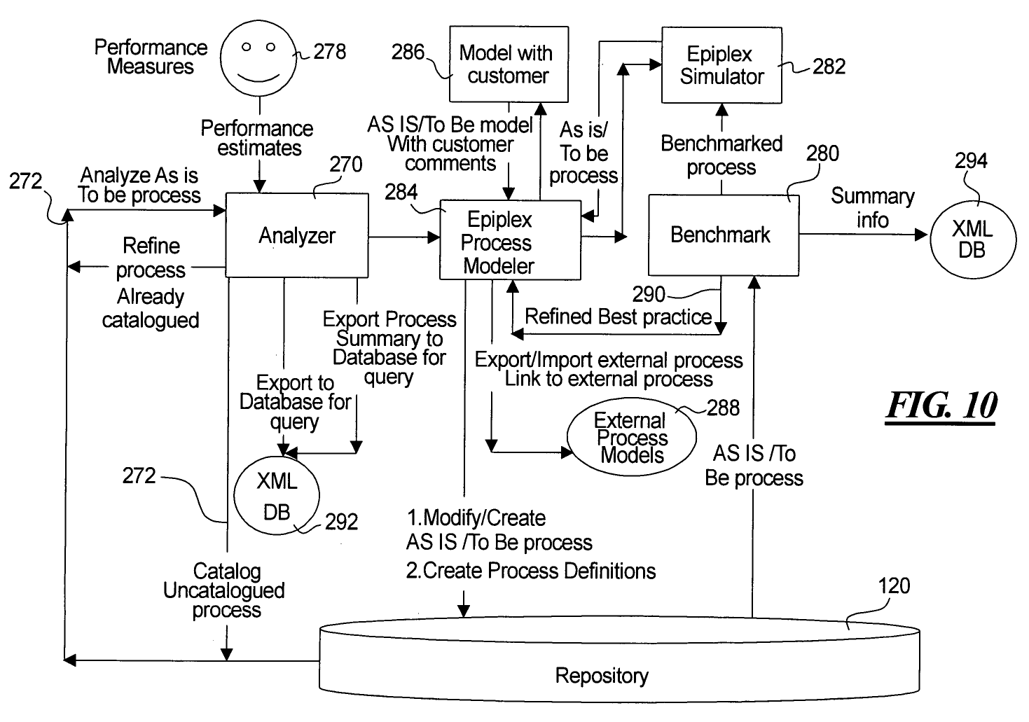

The process analyzer 270 interacts with the modeler 284 to deploy the “as is/to be” processes content to the customers for feedback. This is shown in greater detail in FIG. 11. In particular, the repository 120 provides the target definitions, workflow for approval, “as is” and “to be” processes, content and knowledge objects 296 to model the process 286 with the user or customer 298. Feedback 300 is received with user/customer comments and forwarded to the process modeler 284, which then modifies the processes and forwards the modified process 302 to the repository 120 for storage.

A workflow mechanism can also be set such that the comments, corrections and reviews can be tracked to closure. The process XML files will contain the track of all comments made.

The simulation technology using process models helps analysts in performing various if-then-else condition analysis. For example, the analyst can change a small part of the “as is” process and find out the implications of this in the overall performance of the “to be” process.

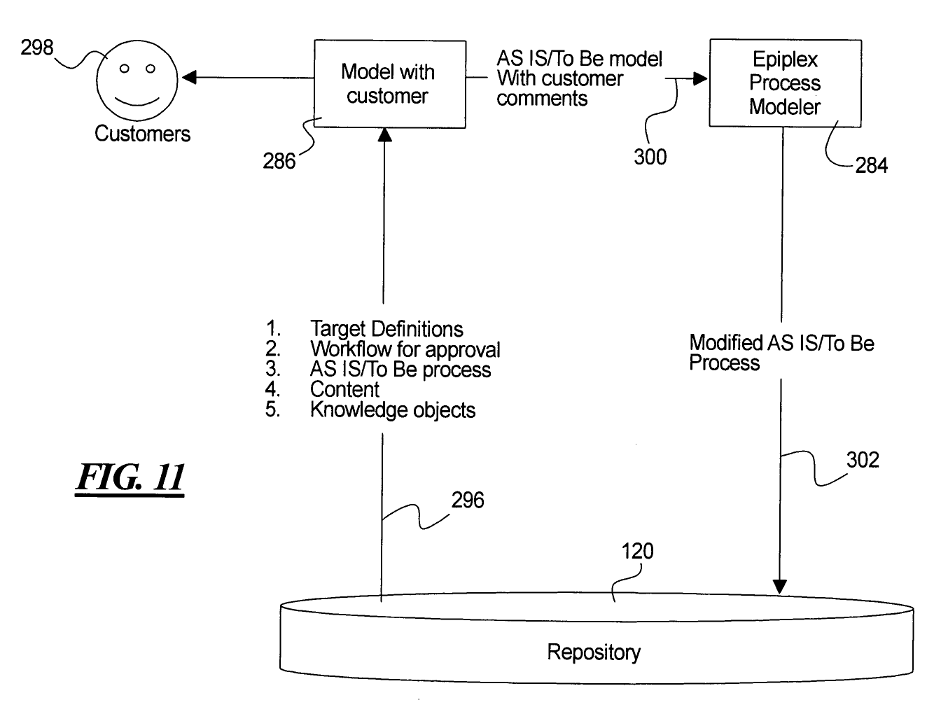

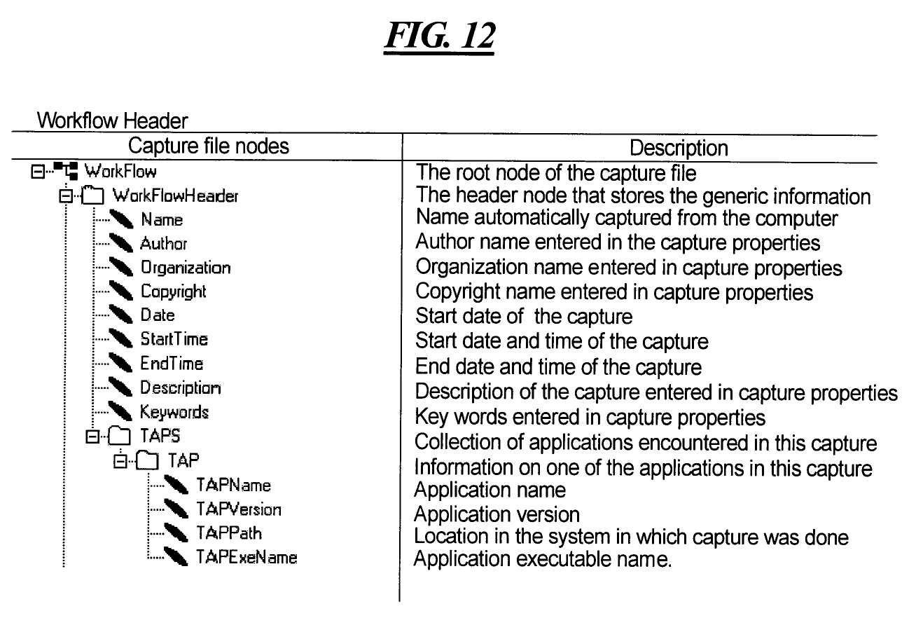

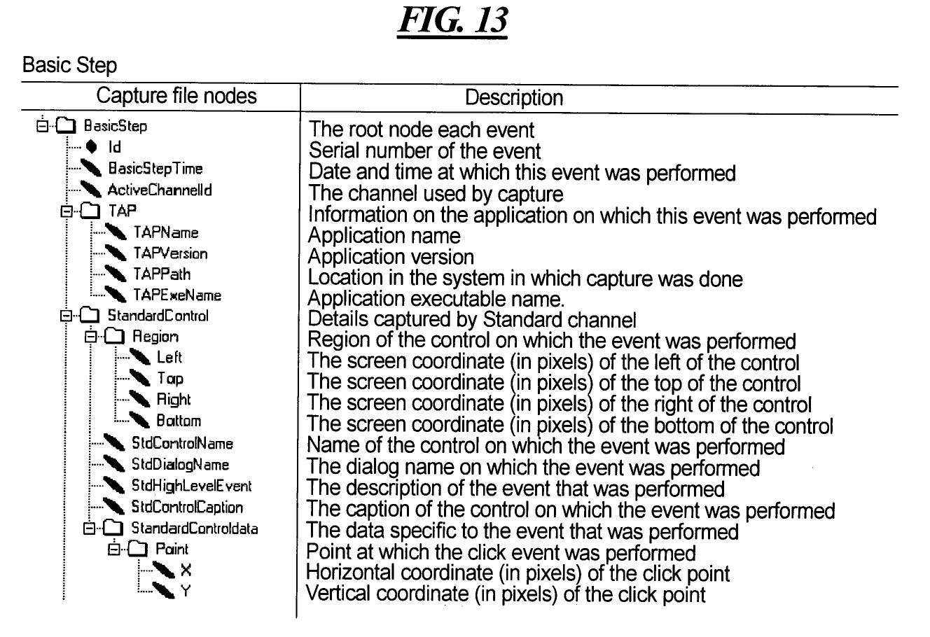

An example of an XML file in which the information is stored during the capture of a user's interaction with a software application is shown in FIGS. 12, 13 and 14. The capture file is divided into two sections, the workflow header (FIG. 12) that has generic information about the capture and a series of basic steps (FIGS. 13 and 14). Each basic step represents an event that was performed and has information specific to that event. The tables of FIGS. 12, 13 and 14 describe the nodes in the workflow header and basic steps, including setting forth the capture file nodes and the description.

The following is a description of information in the XML file. This is a general description of all the relevant information that is captured.

There are four types of data captured

User information

Basic Capture Information

Application information

Step information

For user information, the following information is captured:

1. The name of the user, which is automatically captured from the computer.

2. Author name entered in the processor properties.

3. Organization name as per the license

4. Copyright as entered in the processor properties.

For basic capture information, the following is captured:

1. Start date and time of capture

2. End date and time of capture

3. Description of the capture file entered in the Properties of processor

4. Keywords—This can be used for search purposes. Again entered through the processor.

For application information, the following is captured:

1. Application version

2. Application path

3. Application name

4. Application executable name

For step information, the following is captured:

1. Serial ID of the step

2. Date and time when the event was performed. In one embodiment this is Year-Month-Day-Hour-Min-Sec

3. The channel used for capture—In one embodiment this includes the following channels

a. JAVA

b. MSAA

c. IE Based applications

d. Standard applications

e. 16 bit applications

f. Any other adapter such as SAP etc.

4. Region of control—Gives the top, left, right and bottom of the control which with the user interacted.

5. Control name—name of the control

6. Dialog name—The dialog in which the control is present.

7. High level event such as click, double click, etc.

8. Caption of the control as shown in the label of the control

9. Point X, Y where the click or double-click happened

10. Keyboard Shortcut for the control if any

11. Role of the control (Button, Checkbox etc.). This basically gives the type of control.

12. State of the control—This can be checked, unchecked, etc.

13. Value of the control—Applicable only for textbox, list or combo.

14. Description of the control which is sometimes present.

15. Mouse Button used—right, left or middle button that was used.

16. Special key status with which the mouse action was performed—such as Alt, Ctrl, Shift, etc.

17. Control data—gives the keys that were pressed or data in the control.

18. Parent control name—A control may have a parent.

19. Parent control role

20. Parent control state

21. Parent control value

22. Parent control description

23. Parent control location—Left, top, right and bottom

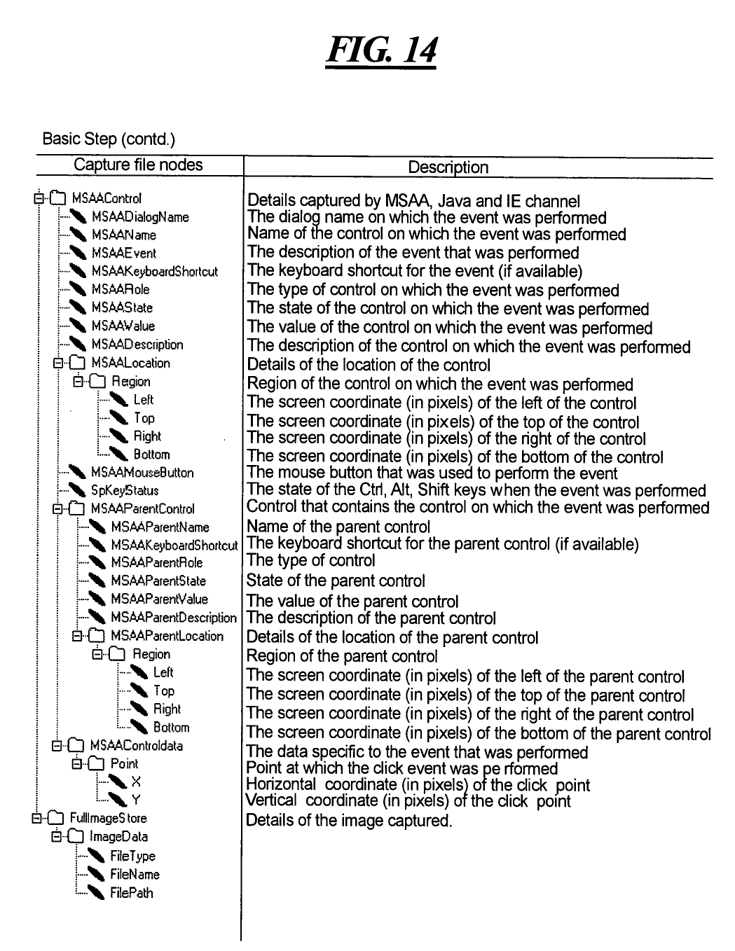

In a sample capture, as shown in FIG. 15, the analyst first deploys remote capture on specific users machines 310. The analysts specifies the following

The duration of capture is specified (2-3 days).

Period of capture

Application to be captures

Applications that should not b captured

Specific processes that needs to be captured.

Based on this, the capture system automatically captures all the user interactions and sends it to a central repository at 312.

The Analyst then sorts out all the processes variations that belongs to a single process. Using the present tools, he then auto generates the process mode at 314. The process model technology analyzes the process file and deduces decisions points, branches and loops. It does this by comparing all the process variations and uses heuristic rules, to construct the process model. At the end of the analysis, a process model is captured which may be around 80% accurate. The analyst can then change the process model and correct inaccuracies if any at 316.

Without the present system the effort required to construct such process models are time consuming. The analyst would have spent a two-week interviewing various users and the recording manually the steps that the users perform. On the basis of this the analyst would have to create a process model. About 80% efforts are spent on creating a first cut process model. All these tasks are eliminated by the present technology. The present technology automates the following:

Capture of processes automatically.

Auto generating the process model given a set of process variations.

Once the process model is obtained, the analyst can create process abstractions and process hierarchies. Process abstractions are application independent of a process. The present technology allows an analyst to crate multiple hierarchy of a process model. For example at the top most level we can specify the main processes such as Respond to customer call. At a more detailed level this process can be broken up. At the lowest level it will translate into specific interactions with a particular RM/SCM application or manual decision points.

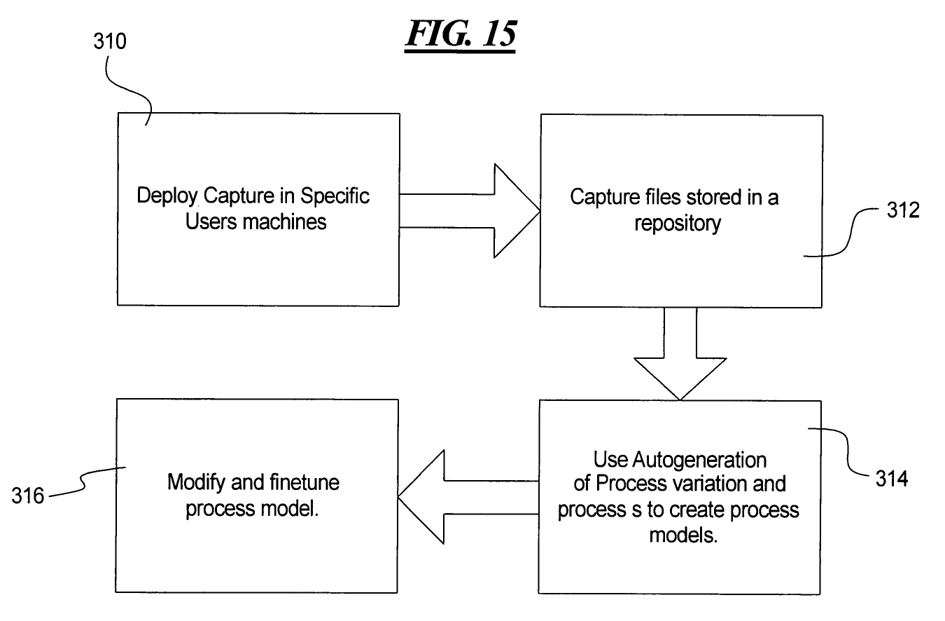

In FIG. 16, is shown an example. Typically in an organization it is very difficult to find out all the processes that are being used. Without the present technology, it would be impossible for the analyst to determine all the processes that are used in the organization.

Using the present technology, the analyst first chooses the department or set of users for which the analyst wants to find out the processes at 320. The capture duration is then set and the remote capture is then pushed to the users machines automatically at 322.

Once the capture is completed, the captures files are stored in a central repository. Using the processes already modeled, the analyst uses the present technology to find out the events that are not a part of any process at 324. This is called as un-catalogued process. Sometimes this may be as high as 50% of the total process. The analyst then can go through the un-cataloged process file and find out all the processes at 326. This is in part a manual job and the present technology helps in only showing the interactions that users performed with the application.

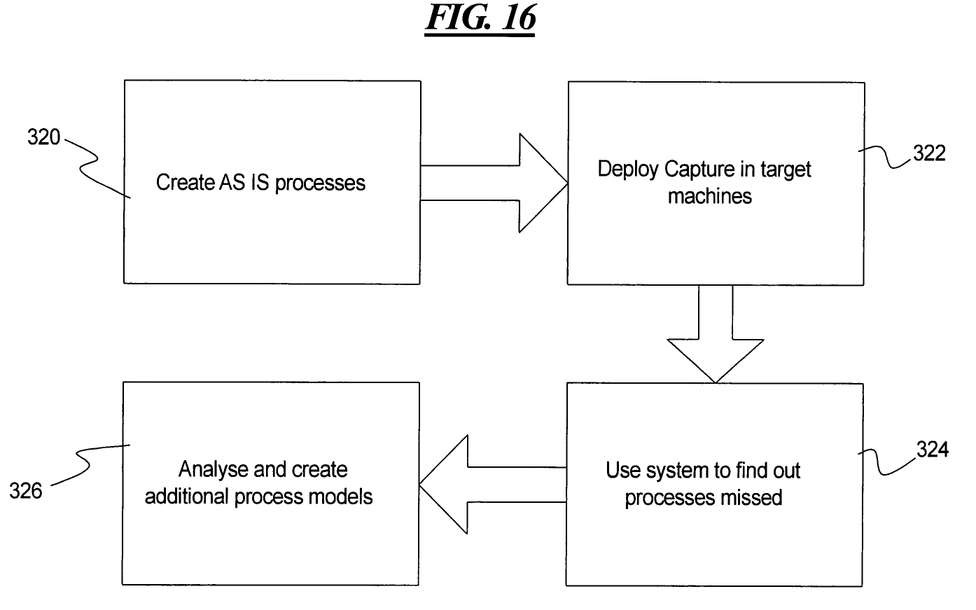

Referring to FIG. 17, once the “as is” process have been identified at 330, the next step is to analyze the existing process and see how they can be improved. So far the analyst had captured only the user interactions. To do a proper study of “as is” process, the analyst may want to study the user actions in more details. The analyst would require not only interactions with the application but also manual tasks. The analyst therefore elects a smaller target group whose process is going to be monitored. Remote capture is then deployed at 332, this time with Audio and Video on. The complete user interactions and the audio and video is shown in an integrated manner by the present system. For example the present technology will show the audio and video between the second and the third step of a process. Using this analyst can find out the exact reasons for process inefficiency. This forms the basis of the “to be” model at 334.

Once the “to be” process is created the business user can benchmark users and compare “as is” and “to be” process performance at 336. To do this, the business manager again deploys remote capture on certain users machines. The processes captured are catalogued automatically by the Process modeling technology. Various key parameters such as, time to perform a process, cost of a process, and error rate of a process are compared between the “as is” process and the “to be” process. The business manager can in fact compare performance of users between any two points in time. This can be:

User's performance between two specific periods. This will establish the efficacy of specific remedial actions. For example the business manager can compare the performance of a user or a set of users before training was given and after training as give. If the performance improves this forms the basis of a ROI of the training program.

Performance between “as is” and “to be” process.

Performance between an two versions of a process.

Performance amongst a group of users.

Performance within a group (Average, Mean, Median).

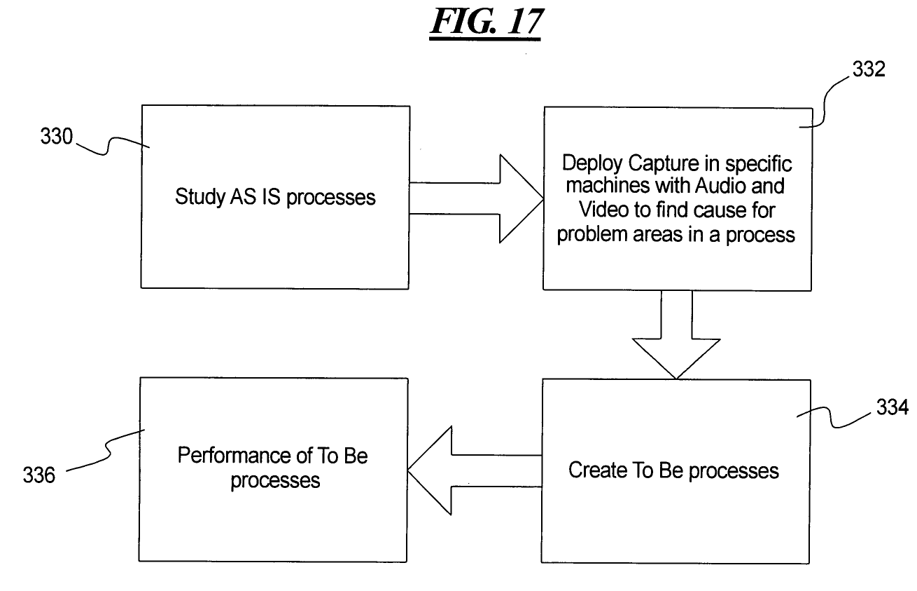

FIG. 18 provides a representation of the application of the present method and system 340, wherein data gathering from users 342 of internal departments, partners and customers of the business is performed, in one embodiment, completely automated. It also provides an automated process 344 for generating an XML database of the process, including audio and video data. This eliminates the time, expense and effort of data gathering. This further ensures complete reliability since the entire population of users may be covered and all biases of the data gathering personnel are eliminated. As shown at 346, the process information, time stamp, audio data, and video data across multiple users is automatically extracted in XML and cataloged for easy grouping and analysis. The XML information can be analyzed with any conventional data base for patterns, inefficiencies and broken process, resulting in an objective and comprehensive view of the processes in use. The present method provides an objective and a rapid method to exhaustively list and identify precise interactions between applications in processes in use. The illustration also shows a mostly automatic “as is” model development 348, providing an efficient and accurate model development cycle. A highly efficient system and method (with an audit trail) provides a means of securing user feedback and acting on them. The “to be” model development includes simulation of performance improvement potential for different scenarios, helps to objectively decide the best projects (what program to use, for what processes, to give what process improvement), and develops a business case for justifying choices that tend to reduce project costs and maximize the achievement of intended benefits.

A computer product is provided for performing the method described herein. The computer product may be supplied as software on computer readable media or via a computer communication such as a network or the Internet. The following table identifies components of the computer product which are provided in one embodiment.

| | |
|---|---|
| Core | Provides the following functionality |
| technology | Capture |
| | Inspect |
| | Track |
| | Notify |
| | Playback |
| | A system processor product uses these functions to |
| | capture events and images. Third party programs |
| | can also request the services of these components |
| Programming | These provide functionality to use the capabilities of the |
| interfaces to | system products. For example, programming developers |
| the system | can use the system processor, documentor, animator, |
| | or analyzer functionality within their programming |
| | environment. |
| Interface to | These APIs provide access to the system XML files. |
| the system | The XML files include the following: |
| XML files | Capture XML file |
| | Knowledge Object XML file |

In summary, the remote capture includes automated capture of events. The captures may include still images, audio and video. The capture is based in target definitions, including scheduling of the capture, identification of applications to capture, identification of processes to capture and identification of events to capture. The remote capture provides automatic capture of business processes, particularly those that employ software applications for a significant portion of the process. The capture coverage is extensive, and can provide continuous process observation and monitoring. The captured events are cataloged at various levels, on-line and in real time. Alternately, the events are captured off line and in batch mode. The capture is performed based on the process definitions.

An upload of the captured material is performed on a schedule or during idle time. The capture is based on security definitions so that there is defined items which are not to be captured. This is defined based on privacy definitions and on privacy acts.

The process analyzer catalogs the un-cataloged processes based on the process definitions. Summary statistics are created for the cataloged and un-cataloged process information. The summary information and process information may be exported to external databases for query and viewing. For processes that have been auto-cataloged, a refining process may be performed. For processes that have been automatically cataloged, further refining can be carried out. A summary of statistics may be created for automatically cataloged processes. The analyzer may also import performance statistics from expert users and from external databases.

The analysis of the “as is” processes, even those that are complex, is facilitated, to permit identification of areas of weakness. A model of the current system is developed using extensive and objective data analysis. Data reusability is provided, as is monitoring of the continuous process improvement. New processes are developed as “to be” processes, and decisions on the purchase or manufacture of software programs is made to deliver the functionality of the process models. Objective measurements are made, simulations are run and estimates provided, all with automated process analysis.

In the process modeler, model charts are created for “as is” and “to be” processes. Charting is performed with multiple hierarchy and the ability to zoom in and out. The “as is” and “to be” process models may be viewed at any level. External processes can be linked to the models and third party models can be imported and exported. Further, the present models can be exported to a database.

The modeler permits the simulation of “as is” and “to be” processes and the prototyping of the “as is” and “to be” process models. The modeler facilitates feedback from the user of the present invention. Another advantage is that the work cycle can be reviewed based on workflow.

In an example of the present system applied to a large organization, the capital expenditure by the organization for enterprise applications is about 38%. Roughly 37% of that amount is spent on annual maintenance and updates of these applications. Of this the following is a rough estimate of amounts spent in various phases: Business Analysis (Determine current processes)—20%, Develop “to be” process—10%, Development and Testing—40%, Deployment—10%, and Training and support—20%.

Utilizing the present capture, analysis and modeling system gives the savings in costs associated with business analysis and development of “to be” processes. By automatically capturing and cataloguing the processes, the present system removes the burden of manually capturing the processes. Also, the present system provides more accuracy and captures all of the information, which would not have been possible otherwise. The present system provides a significant savings in the development of “to be” process through the application of the analysis and modeling technology.

The present invention contextualizes the content with the user context in the application. In other words, the user's actions are placed into context with the operations being performed on the software application so that an understanding of what is being done by the user is possible. Since actual business processes being performed by a user are captured, the accuracy of the process is never in doubt. There is no need to rely on interview and questionnaires since the actual event is being recorded. If the user's interactions accomplish what the user set out to do, the user can be sure that what has been captured is an accurate step-by-step recording of the process.

The whole interaction is available in XML format and represents a complete and detailed transcript of the process. The audio and video recording is marked with markers indicating the steps being performed and the media files between steps may be played back to determine what occurred between each captured step. The collective XML information is analogous to a relational database of financial data. Extraction and reconstruction of interactions, creation of multi-dimensional analysis and presentation of information can be performed in a myriad of ways since the data is present.

According to the invention, the data is captured once and may be rendered many times. The XML record may be used to generate several different types of output. An auto generate function may provide a simplified process user interface that automates a human interaction with applications by asking key human fed data once. A live-in application guide may be generated. The XML record provides a complete documentation of the business process. Further, it may be used as a complete animation, simulation and test for the business process.

A further use of the XML record is to apply the content and other business logic to process context and goals. In another embodiment, the XML record is used to apply language style sheets and templates to present content in a variety of formats and languages. In yet another aspect, the XML record is used to apply benchmark tags or event notification tags to report real time process events.

The business user's processes are tracked in a desktop knowledge capture system. Business users as well as analysts and specialists obtain real time business knowledge, best practices and process information as well as front end automation and intelligence of real world business processes that are used. Context-aware applications are transformed into context-interactive applications by tracking user context.

Once a business process is captured, it can be rendered in different formats for different purposes using specific editors. By separating content from logic and presentation, flexibility in creating a rich range of content is enhanced. The invention can scale to capture any business process on any Windows platform and can extend business process execution in a way that is agnostic of the platform, applications, or devices. It is foreseen that it can envelope complex end-to-end process (cross-enterprise, multi-platform environments) execution literally at a touch of a button through new and practical user interfaces across small form factor devices or larger desktops.

In the present invention, the capture technology may include components termed “listeners.” The invention has sophisticated listeners which can listen to data exchanges within and between various kinds of applications (IE-based, Windows Applications, JAVA applications). Third party applications can use the listeners to listen to events.

The present invention utilizes what is termed “deep capture” to model complex processes and workflows. A process definition can model even the most complex processes, and can include: Linear or non-linear steps to be performed in an application; workflow elements involving branching and looping; manual tasks or legacy content; and hierarchy of steps. For example, the first ten steps of a process can be combined and grouped under a sub-process “enter order information”. Tracking and content automatically inherits the hierarchy definition of the process.

The present method and system provides improvements which previously were too costly to implement. The conventional methods costs about five times the time and effort to capture what is possible using the present approach. Further, certain interactions such as what exactly was done on an application is very difficult to do using only video or audio technologies. Very often questionnaires that were used missed out crucial pieces of information that are now available with the present method. The present method also allows automatic analysis and finding out who did what processes without human intervention.

The automatic process of the present method provides a cost savings of about 80% over previous approaches, automatic analysis and finding out which users performed which processes, finding out process bottlenecks much faster, digital cataloging of processes in an XML format and usage with other tools, automatic generation of content for end users. This would not have been possible but for automation of the business process capture function.

The present method and system provides for capture in a hierarchical fashion. Processes are broken up into sub-processes and this is done while capturing itself. The present method and system captures information on all controls in a screen. In addition to the capture, the present technology also includes process modeling, auto generation of content, auto generation of performance support components, auto generation of a process from process interactions, auto creation of a process model given a set of processes carried out by the users, and WYSIWIG complex content creation (including decision points).

Thus, the present invention provides technologies that result in better processes.

Although other modifications and changes may be suggested by those skilled in the art, it is the intention of the inventors to embody within the patent warranted hereon all changes and modifications as reasonably and properly come within the scope of their contribution to the art.

1. A method for modeling a process, comprising the steps of:
remotely capturing actions of a user in performing the process;
storing said captured actions as captured data files;
cataloging said captured data files; and
modeling the process using said captured data files.

2. A method of process capture, comprising the steps of:
automated remote capturing of a process performed by a user, said capturing including capture of the user's interactions with a computer;
generating captured process files of said captured process; and
storing said captured process files in a storage.

3. A method as claimed in claim 2, wherein said captured process files are in XML.

4. A method as claimed in claim 2, wherein said automated remote capturing includes capture of at least one of audio data and video data to record actions of the user in performing the process.

5. A method as claimed in claim 2, wherein said generating files includes including context information in said captured process files.

6. A method as claimed in claim 5, wherein said context information includes inserting time stamp data in said captured process files.

7. A method as claimed in claim 5, wherein said context information includes information from listeners reporting communications between software components and an operating system.

8. A method as claimed in claim 5, wherein said context information is derived from virtual footprints in computer software used at least in part to perform the process.

9. A method as claimed in claim 8, wherein said virtual footprints include captures of at least one of dialogs, toolbars and menus of a software application on said computer.

10. A method as claimed in claim 2, wherein said step of automated remote capture captures processes of a plurality of users.

11. A method as claimed in claim 10, wherein different levels of capture are provided for different ones of said plurality of users.

12. A method for modeling a process, comprising the steps of:
remotely capturing actions of a user in performing the process on a computer;
storing said captured actions as captured data files; and
streaming the captured data files to a computer to simulate a user performing the process.

13. A method as claimed in claim 12, further comprising the steps of:
editing said captured data files to create edited data files; and
streaming said edited data files to a computer to simulate a user performing an edited process.

14. A method as claimed in claim 13, wherein said captured data files constitute an as-is model and wherein said edited data files constitute a to-be model of the process; and comparing said as-is model to said to-be model.

15. A method for modeling a business process in a business or organization having a plurality of computers connected to a network, comprising the steps of:
defining capture settings of users using said plurality of computers;
remotely capturing interactions with said plurality of computers according to said capture settings as capture data files; and
storing said capture data files in a repository.

16. A method as claimed in claim 15, wherein said defining includes setting different levels of capture for different ones of said plurality of computers.

17. A method as claimed in claim 16, wherein said different levels of capture are distinguished by presence of at least one of audio recording and video recording of a user's actions in performing the process.

18. A method for identifying a process, comprising the steps of:
remotely capturing actions of a user in performing the process;
storing said captured actions as captured data files; and
automatically cataloging said captured data files by pattern matching of said captured data files against a process definition.

19. A method as claimed in claim 18, wherein said cataloging includes applying fuzzy logic to ones of said captured data files to partially catalog said ones of said captured data files.

20. A method as claimed in claim 18, wherein said cataloging includes storing ones of said captured data files as un-cataloged data files.

21. A method of process capture, comprising the steps of:
automated remote capturing of a process performed by a user, said capturing including capture of the user's interactions with a computer;
automated remote capturing of at least one of audio and video data of the process performed by the user;
generating captured process files of said captured process including flagging portions of said at least one of said audio and video data to corresponding interactions of the user with the computer; and
storing said captured process files in a storage.

22. A system for modeling a process on a computer, comprising:
capture software on the computer operable to capture as data files actions of a user in performing the process;
an identification system connected to the computer and operable to identify the data files as corresponding to actions in performing the process;
a cataloging system connected to said identification system and operable to sort the data files into identified and unidentified files;
a data storage connected to receive said identified and unidentified files;
a modeling system connected to a computer to stream said data files to the computer for emulation of the process.

23. A system for process capture, comprising:
connections to inputs of a computer through which remote capture is made of a process performed by a user including capture of the user's interactions with the computer;
a data manager connected to said input connections from which captured process files of said captured process are forwarded; and
a data storage connected to receive said captured process files from said data manager.

24. A system as claimed in claim 23, further comprising:
at least one of audio data and video data recording devices connected to said data manager to record actions of the user in performing the process.

25. A system as claimed in claim 23, further comprising:
context elements in said computer operable to include context information in said captured process files.

26. A system as claimed in claim 25, wherein said context information includes time stamp data in said captured process files.

27. A system as claimed in claim 25, wherein said context elements include listeners operable to report communications between software components and an operating system of the computer.

28. A system as claimed in claim 25, wherein said context information is at least one of dialogs, toolbars and menus of a software application on said computer.

29. A system as claimed in claim 23, further comprising:
connections to a plurality of computers of a plurality of users; and
said data manager connected to all of said connections.

30. A system as claimed in claim 29, further comprising:
an administrator interface operable for setting different levels of capture are provided for different ones of said plurality of users.

31. A system for modeling a process, comprising:
a remote capture apparatus connected to capture actions of a user in performing the process on a computer;
a data storage connected to receive said captured actions as captured data files; and
a connection to a computer to stream the captured data files to the computer to simulate a user performing the process.

32. A system as claimed in claim 31, further comprising:
an interface by which said captured data files may be selectively edited to create edited data files; and
said connection to the computer streaming said edited data files to the computer to simulate a user performing an edited process.

33. A system as claimed in claim 13, further comprising:
a comparison apparatus operable to compare said captured data files to said edited data files.

34. A system for modeling a business process in a business or organization having a plurality of computers connected to a network, comprising:
an interface operable to define capture settings of users using said plurality of computers;
remote capture connections to capture interactions with said plurality of computers according to said capture settings as capture data files; and
a data storage connected to receive said capture data files.

35. A system as claimed in claim 34, further comprising:
at least one of audio recording equipment and video recording equipment connected to record at least some user's actions in performing the process at at least some of said plurality of computers.

36. A system for identifying a process, comprising:
remote capturing elements operable to capture actions of a user in performing the process;
a data storage connected to said remote capture apparatus to receive said captured actions as captured data files; and
a cataloging element connected to receive said captured data files and operable to perform pattern matching of said captured data files against a process definition.

37. A system as claimed in claim 36, wherein said cataloging element includes a fuzzy logic component operable to assign partial identifications to ones of said captured data files.

38. A system as claimed in claim 36, wherein said data storage includes a portion for cataloged files and a portion for un-cataloged files and said cataloging element forwards unidentifiable files to said un-cataloged portion of said data storage as un-cataloged data files.

39. A system of process capture, comprising:
an automated remote capturing software element in a computer operable to capture a process performed by a user, said capturing including capture of the user's interactions with the computer;
at least one of audio and video data capturing devices of the process performed by the user;
a data manager connected to said automated remote capturing element and said at least one of said audio and video data capturing devices to pass captured process files of said captured process including flagging portions of said at least one of said audio and video data to corresponding interactions of the user with the computer; and
a data storage connected to receive said captured process files.
